(19) United States
(12) Patent Application Publication
(10) Pub. No.: US 2015/0195676 A1
(43) Pub. Date: Jul. 9, 2015

(54) SYSTEM AND METHOD THROUGH WHICH PEOPLE INVOLVED IN AN EMERGENCY SITUATION CAN COMMUNICATE AND SHARE REAL-TIME, ELECTRONIC, INFORMATION AND SITUATIONAL AWARENESS WITH EACH OTHER AND WITH PUBLIC SAFETY PERSONNEL DURING EMERGENCY SITUATIONS

(71) Applicant: OnScene Technologies, Inc., Ramsey, NJ (US)

(72) Inventors: ERIK ENDRESS, RAMSEY, NJ (US); ADRIAN LANNING, NORWALK, CT (US)

(73) Assignee: ONSCENE TECHNOLOGIES, INC., Ramsey, NJ (US)

(21) Appl. No.: 14/592,663

(22) Filed: Jan. 8, 2015

Related U.S. Application Data
(60) Provisional application No. 61/925,195, filed on Jan. 8, 2014.

(51) Int. Cl. H04W 4/02; H04W 76/00; H04L 29/08; H04W 4/22

(52) U.S. Cl. CPC H04W 4/02; H04W 4/22; H04W 76/007; H04L 67/306

(57) ABSTRACT

This invention relates generally to communication and the incident-reporting process during emergency situations, but not exclusively, to systems and methods for providing a location-based, emergency social network.

### CROSS-REFERENCE TO RELATED APPLICATION

The present application claims the benefit of U.S. Provisional Application Ser. No. 61/925,195, filed Jan. 8, 2014, the entire disclosure of which is expressly incorporated herein by reference.

### FIELD OF THE INVENTION

This invention relates generally to communication and the incident-reporting process during emergency situations, but not exclusively, to systems and methods for providing a location-based, emergency social network.

### BACKGROUND

Security systems are known in the art. However, typically, these systems are designed for passive monitoring with a telephone notification to a 911 center or central station. Most, if not all, of these are directed to home protection or building protection at times when the building or home is not occupied. Currently, many public facilities such as schools, courthouses, other government buildings, sports facilities and hotels have generic alarm systems, such as fire alarm bells or horns that ring throughout the entire facility and are intended to direct all occupants to evacuate the building. Typically, the alarms give no assistance to responding personnel and do not permit clarifying or change in status of event-in-progress information being provided to the occupants to supplement the initial raw alarm information. The usual response to such alarms is to evacuate the building through pre-assigned exit routes, assemble at pre-assigned points, and await instruction. There is little, if any, flexibility in the alarm and response system; communication is tenuous, slow and difficult to control and subject to failure. In addition, there is no means to share information between and among building personnel and emergency personnel.

Emergency telephone numbers, such as “9-1-1,” are known in the art (hereinafter “911”). However, the current 911 system in the United States is limited to telephone calls only. In addition, information can only be provided to the 911 operator, not directly with the emergency services providers or others who could assist the person in distress. Moreover, even if 911 operators are notified and first responders respond to the emergency, there is currently no system in place for ongoing, real-time monitoring of individual(s) involved in the emergency situation which was reported to 911.

Mobile-based, emergency notification technology using GPS is known in the art. However, this technology relies solely on the use of GPS and mobile technology, which may be unreliable or inaccurate in certain instances. For example, if an individual's GPS device is not visible to the satellite, their location cannot be determined, rending this technology useless.

Accordingly, there is an unmet need in the art for a system whereby individuals located on the scene of an emergency can communicate with each other, as well as public safety personnel en route to or on the scene, quickly and easily by accessing a computer or mobile device that has Internet connectivity. Furthermore, there is a need for a system that can perform the following functions:

(a) account for all individuals whom are registered to be on scene by specific location;
(b) identify any missing individuals;
(c) provide status updates when missing individuals are located;
(d) permit feed-into and feed-back between remote sites and law enforcement;
(e) permit triggering of alerts from any authorized user with Internet connectivity from any area in the building;
(f) trigger different types of alerts (e.g., lockdown, lockout, evacuation, all clear and incident updates/notifications) for different types of events;
(g) permit “silent” alarms;
(h) permit obtaining from, or providing clarifying information to, authorities and responders;
(i) permit change in alarm nature or status as the event unfolds, including an end-event “all clear;” and
(j) permit access to database of prior collected information, such as maps of the facility, site layout, building personnel, and evacuation zones.

Furthermore, there is a need for a system with “Accountability Reporting” functionality that enables accountability in real-time, online. In addition, there is a need for a system that includes mapping technology that allows individuals to “check-in” at predetermined locations, allowing building personnel and public safety personnel to account for and locate individuals in the building in real time. In addition, there is a need for an “Incident Report” functionality that enables the creation of incident reports which generate notifications to authorized users who view real-time updates to each incident report.

### SUMMARY OF THE INVENTION

The present invention provides a major improvement and satisfies an unmet need over other systems currently in use.

The present invention provides a method for providing a location-based, emergency social network, that includes the steps of: configuring a network profile including: a name of a place associated with an address; an email domain associated with an entity that occupies the address; a unique network identifier specific to a network profile; an identifier regarding the type of place or entity that occupies the address; a physical address, comprising indicators selected from the group consisting of: street address, city, county, state, zip code, and combinations thereof, where the place is physically located; a time zone associated with the physical address; and a password; configuring a check-in location for each unique place, associated with the network profile, from which a network user may select indicators selected from the group consisting of: a location name, a floor of the building, a side of the building, a closest entry door, and combinations thereof; configuring a network user profile, wherein a plurality of data inputs from the user is selected from the group consisting of: a user's name, an email address, a password, a mobile phone number, a job title, a position title, a name of an emergency contact, a phone number of an emergency contact, a user's preference for receiving alerts, a selection of favorited check-in locations, and combinations thereof; configuring an agency profile, wherein said agency profile is associated with a public safety agency and wherein said agency profile comprises information selected from the group consisting of: an originating agency identification number, a name of an agency, an email domain associated with the agency, a physical street address, a zip code associated with a network profile for which members of the agency may have access and visibility to, and combinations thereof; configuring an agency user profile, wherein the plurality of data inputs from the user comprises: an agency user's name, an agency's email address, a password, a mobile phone number, a job position, a job title, an agency user's preferences for receiving alerts from each network, and combinations thereof.

The present invention provides a method for a network user or agency user to issue an emergency alert to a plurality of users associated with a network profile of an emergency situation including: selecting a type of emergency alert from a pre-determined list of stored alerts; identifying the recipients of the emergency alert by a location, wherein the location is selected from the group consisting of a floor of a building, wherein the location is associated with a network profile, a network user's profile, and a check-in location shared by a network user; attaching a text based, user-generated message to an emergency alert; sending the selected emergency alert and message to a server for distribution; utilizing a server to attach a link associated with the emergency alert created by a user to where the link enables a viewing user to share with or view information shared by the plurality of users; and delivering the emergency alert, message, and link to the plurality of users and agency users associated with a network profile, based on each users preference for receiving alerts, wherein said alerts may be selected from the group consisting of: an SMS message, a text message, an email, a desktop notification, an online notification, and combinations thereof.

The present invention provides a method for a network user or agency user to issue an emergency message to a plurality of users associated with a network profile of an emergency comprising: identifying the recipients of the emergency message by the floor or floors of a building which are associated with the network profile, the network users profile, and check-in location shared by a network user; attaching a textual, user-generated emergency message; sending the selected emergency message to a server for distribution; and delivering the emergency message to the plurality of network users and agency users associated with a network profile, based on each users preference for receiving alerts, wherein said alerts may be selected from the group consisting of: an SMS message, a text message, an email, a desktop notification, an online notification, and combinations thereof.

The present invention provides a method for each network user to share emergency information, in the form of a check-in, with a plurality of users associated with a network profile including: generating a server-supplied user interface to each user, for the purpose of checking-in; receiving the status of the network user from a list of statuses stored in a database associated with a network profile; receiving the location of the network user from a list of locations stored in a database associated with a network profile; receiving the number or range of people who are with a network user from a list of numbers or ranges stored in a database associated with a network profile; receiving a textual message from the network user; receiving the first and last name(s) of persons who the network user is reporting to be missing, found, absent or off-site; attaching the users check-ins status, location, headcount, textual message and the names of missing, found, absent or off-site persons; and sending the attachment to the server.

The present invention provides a method for each network user or agency user to view, in real-time, the emergency information, known as check-in's, as it is being shared by the plurality of users associated with a network profile including: storing, in a database on a server, the emergency information being shared by the plurality of users; generating a server-supplied user interface to each user for the purpose of providing real-time visibility to the emergency information being shared by the plurality of users; associating the data contained in the network user profile with the check-in data the network user has shared for the purpose of displaying a status card that associates that information; organizing and displaying in real-time, the emergency information, being shared by the plurality of users, based on the chronological order in which it was shared; organizing and displaying in real-time, the emergency information, being shared by the plurality of users, based on the status selected by each user; organizing and displaying in real-time, the emergency information, being shared by the plurality of users, based on the location selected by each user; and organizing and displaying in real-time, the emergency information, being shared by the plurality of users, in alphabetical order based on the last name of each user.

The present invention provides a method for each network user or agency user to view, in real-time, the network users who have not shared emergency information or checked in to a network profile including: storing, in a database on a server, the profile information for each network user associated with a network profile; generating a server-supplied user interface to each user for the purpose of providing real-time visibility to the emergency information or check-in status of each network user; organizing and displaying the network profile information for those network users who have not shared emergency information or checked in as not reported; enabling each network user to share emergency information or check-in on behalf of a network user who is displayed as not reported by interacting with their status card.

The present invention provides a method for each network user or agency user to share or view, in real-time, names or identities of people who have been reported missing, found, absent or off-site by the plurality of users associated with a network profile including: storing, in a database on a server, the data, the names or full name of people who have been reported missing, found, absent or off-site by each network user or agency user; generating a server-supplied user interface to each user for the purpose of providing real-time visibility to a user's accountability status cards that contain the names of people who have been reported missing, found, absent or off-site shared by the plurality of users; associating the data contained in the network user profile with the check-in data the network user has shared, with the names of people who they have reported missing, found, absent or off-site for the purpose of displaying an accountability status card that contains that information; and enabling each network user or agency user to account for persons reported missing by interacting with their specific accountability status card.

### BRIEF DESCRIPTION OF THE DRAWINGS

The invention is described in more detail with reference to the drawings, in which:

FIG. 1 shows the components of the inventive system in an exemplary embodiment.

FIG. 2 is an exemplary “map” of a typical school facility showing the context in which the inventive system is applied.

FIG. 3 is a logic flow diagram of an example sign-in process that may be performed in accordance with aspects of the invention.

FIG. 4 is an example screen shot of display screens that may be presented to the user in accordance with aspects as described herein.

FIG. 5 is a logic flow diagram of how a user reports an incident.

FIG. 6 is a screen shot showing the Broadcast Center on which a user can report an incident.

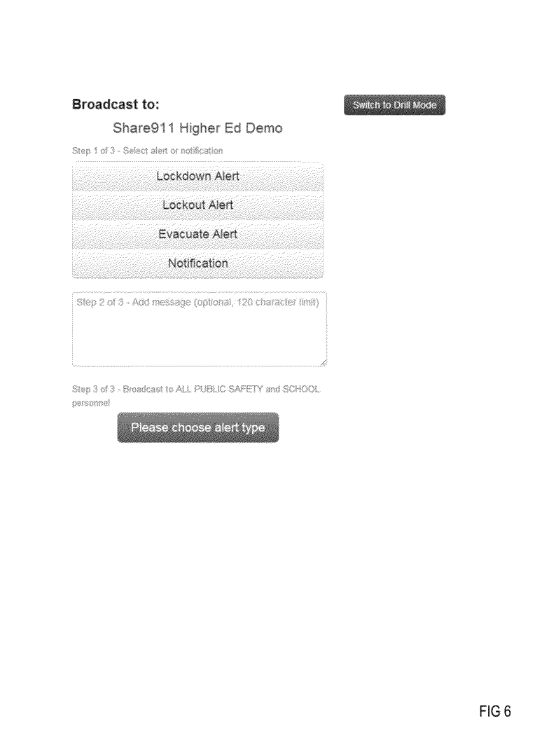

FIG. 7 is a logic flow diagram of how a user checks in.

FIG. 8 is a screen shot showing how a user checks in.

FIG. 9 is a logic flow diagram showing how a map of a school is integrated onto the inventive system's server.

FIG. 10 is a logic flow diagram of how a user reports individuals as missing, absent or found.

FIG. 11 is a screen shot showing the Report Accountability page on which a user reports individual(s) as missing, absent or found.

FIG. 12 is a screen shot showing an exemplary card of an individual who was lost and then found.

FIG. 13 is a screen shot showing a “By Check-in Status” view in Live View.

FIG. 14 is a screen shot showing the “By Last Name” View in LiveView.

FIG. 15 is a screen shot showing the “Missing Persons” View in LiveView.

FIG. 16 is a logic flow diagram of how a user can access and/or edit public safety Agency, school and user profiles.

FIG. 17 is a screen shot showing what a user would see when selecting “Public Safety Agency” from the drop-down menu under the user's name.

FIG. 18 is a screen showing the page on which a user would input information to create a new public safety agency profile.

FIG. 19 is a screen shot showing the page on which a user would view and/or edit information pertaining to an existing public safety agency.

FIG. 20 is a screen shot showing an exemplary current public safety agency personnel list.

FIG. 21 is a screen shot showing a page on which a user would import a public safety agency personnel.

FIG. 22 is a screen shot showing a page on which a user would input information to create a new school profile.

FIG. 23 is a screen shot showing the page a user would see when switching schools.

FIG. 24 is a screen shot showing the page a user would see when updating the user's profile.

FIG. 25 is a screen showing the page a user would see when changing the user's password.

FIG. 26 is a screenshot that includes directions for using the inventive platform that are contained on the Site under “Help.”

### DETAILED DESCRIPTION AND BEST MODE OF IMPLEMENTATION

The inventive platform (hereinafter “inventive platform,” “inventive system,” and “Share911” may be used interchangeably”) is a javascript-based web-application that is universally accessible and platform agnostic. As such, a user can access it from anywhere the user has a javascript-enabled web-browser with Internet connectivity. Because it is a secure website and not an “app”, the usage of the site is the same regardless of how a user accesses it.

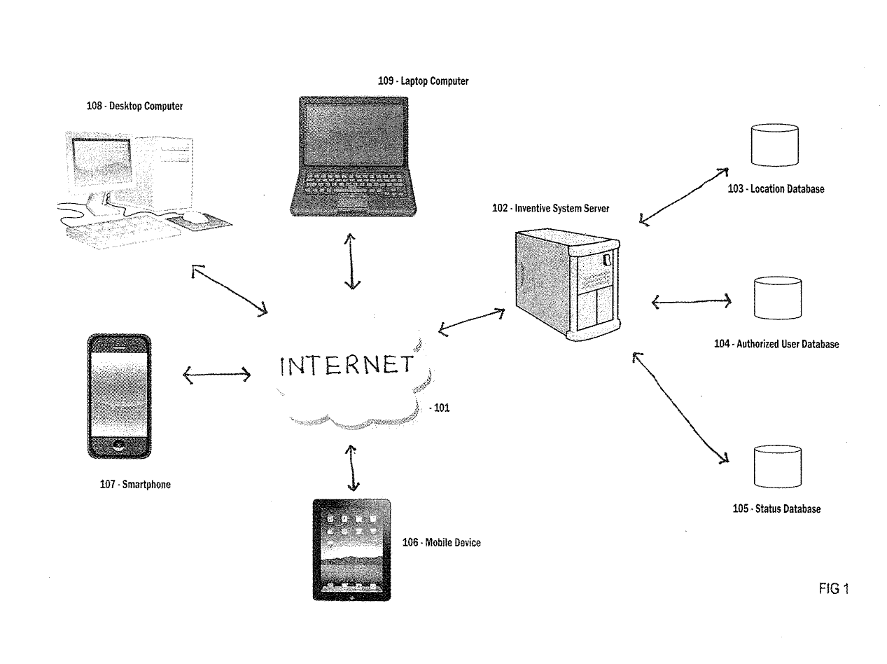

As shown in FIG. 1, the inventive system 100 includes Internet 101, inventive system server 102, location database 103, authorized user database 104, status database 105, laptop computer 109, desktop computer 108, smartphone 107, mobile device 106. A user 10 can log in from his or her desktop computer 108, a laptop 109, an Internet-enabled appliance 106 (i.e. a tablet device, where a tablet device may include an Apple iPad, Samsung Galaxy, Microsoft Surface, Amazon Kindle, Google Nexus, and the like), or a mobile phone 107, if the mobile phone has a javascript-enabled browser. As also shown on FIG. 1, a list of all authorized users 104 and each possible status 105 is contained on the Inventive System's server. As also shown on FIG. 1, a list of locations within each registered building/place 103 is contained on the Inventive System's server, which is accessible to the user on the check-in screen of the inventive system's website (hereinafter “inventive system's website,” Share911.com,” and the “Site” may be used interchangeably.).

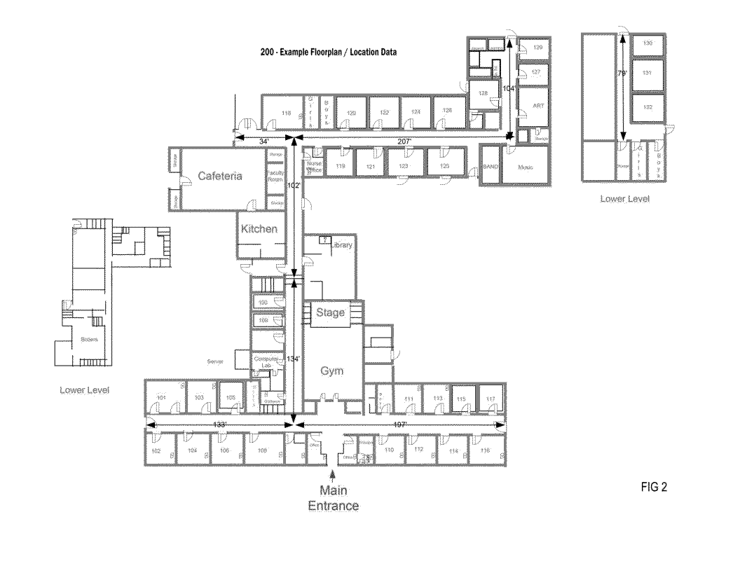

FIG. 2 is an exemplary map of a typical school facility showing the context in which the Inventive System is applied. The map itself will be contained on the Inventive System's server so that public safety personnel can quickly and easily locate individuals inside the building during or after an incident. Each customer of the Inventive System using the Inventive System's platform may provide a detailed map 200 of the building(s) and surrounding area of such location. Each room, hallway, open space and closet displayed on the map are coded and contained in the database located on the Inventive System's server. By using pre-determined locations that the user selects each time he or she checks in, the Inventive System can group and filter that information for emergency personnel and building officials.

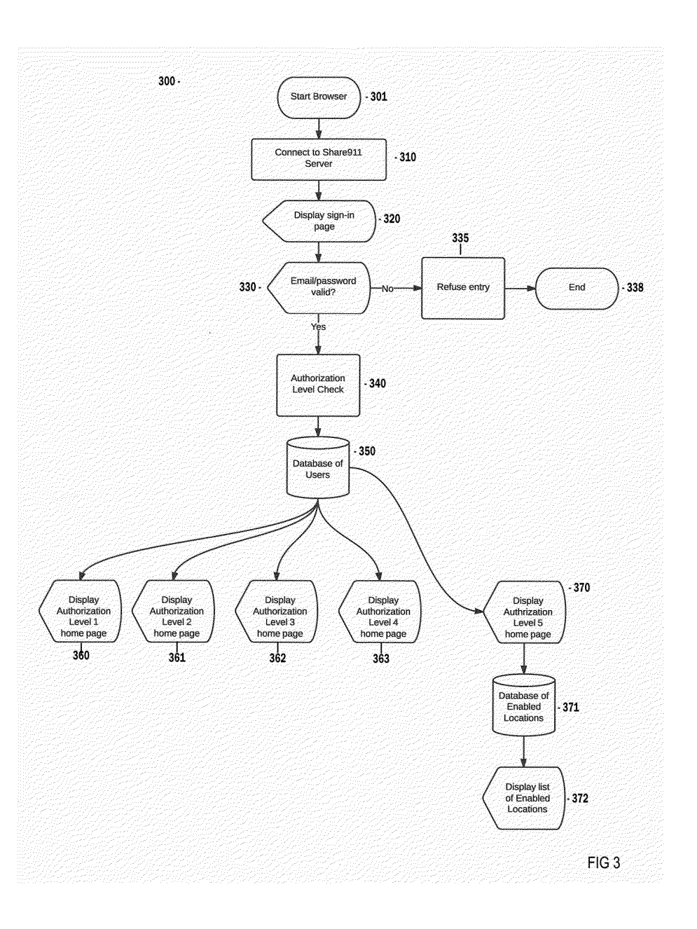

FIG. 3 is a logic flow diagram of the sign-in process with authorization level filter. 300 Each time a user connects to the Inventive System's platform 310, a sign-in page is displayed 320 indicating a place for the user to provide his or her email and password. 330

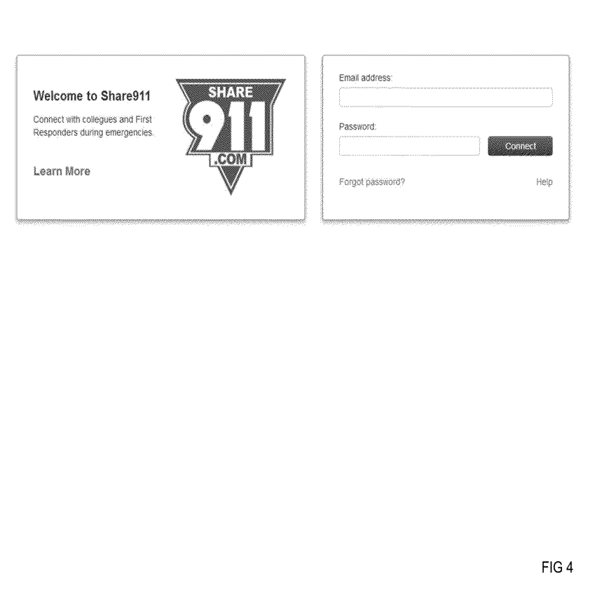

FIG. 4 is a screen shot that a user sees when logging onto the Site. The user clicks on the “connect” button 310 and, if the user's name is contained in the Share911 database of users (“Authorized User” or “AU”), then an authorization level filter is triggered 340 such that each level of user is only able to access certain areas of the Site. The number of authorization levels may be determined by the Inventive System's customer and are completely customizable based on the customer's desired use of the Inventive System. In some embodiments, there may be 1-20 authorization levels.

In this embodiment, as exemplified in FIG. 3, there are five (5) authorization levels. 360, 361, 362, 363, 370. A Level 1 (360) AU, for example a teacher at a school, would be given the option to view the Check-In, LiveView and Account Management features.

A Level 2 (361) AU, for example a principal at a school, would be given the option to view the Broadcast, Check-in, LiveView and Account Management features.

A Level 3 (362) AU, the safety team who may include a fire warden or school resource officer, would be given the option to view the Broadcast, Check-in, LiveView, Account Management features and receive specific incident updates or notifications which would be sent to either all non-police or the safety team only.

A Level 4 (363) AU, for example a school superintendent or IT Director, would be given the option to view the Broadcast, Check-in, LiveView, Account Management and Manage Place features.

A Level 5 (370) AU, public safety personnel, would be given the option to view the Broadcast and LiveView screens. In this embodiment, if a Level 5 AU signs onto the Site, the first screen that such AU would see is a list of the Inventive System's enabled locations 372 that are associated with that AU. An enabled location is a location (e.g., a school) that has been linked to a specific AU on the Inventive System's database of enabled locations 371 (“Enabled Location.”) The AU selects the locations that the AU wishes to view which then brings the AU to the Live View for that location. If a Level 1 or 2 AU signs onto the Site, such AU will automatically see a Check-In screen.

The Inventive System typically is used in the context of a building emergency as follows: Once an AU successfully signs onto the system, the AU can broadcast an alert which can, for example, notify Authorized Users to lock down or evacuate.

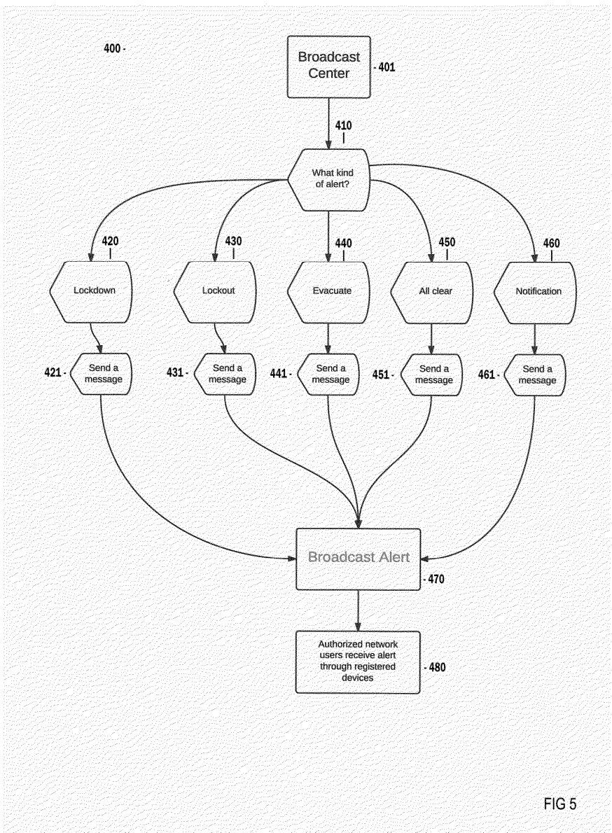

FIG. 5 represents a logic flow diagram of how an AU reports an incident through the Broadcast 400 feature. Broadcast 400 enables the electronic communication of building safety information via the Site, emails and text messages. When an AU enters Broadcast Center 401, the AU will be prompted to indicate what kind of alert 410 they want to broadcast. Depending upon the AU's authorization level, the AU may choose from a variety of options that are determined by the Inventive System's customer and are completely customizable based on the customer's desired use of the Inventive System. For instance, an airport may want to issue alerts that state: emergency landing, fire, bomb threat, security breach. A hospital might issue alerts that state: weather emergency, missing patient, fire, intruder, gas leak, or other emergencies relevant to a hospital. A shopping mall may want to issue alerts that state: fire, bomb threat, missing person, gunman, gas leak, shoplifter. A zoo may want to issue alerts that state: missing animal, missing person, flood. In this embodiments, as exemplified in FIG. 5, the AU may choose from the following options: (1) lockdown 420; (2) lockout 430; (3) evacuate 440; or (4) all clear 450. Lockdown 420 may include an emergency protocol to prevent a person from escaping or entering the building. For example, an AU might select lockdown 420 if a gunman has entered the building. Lockout 430 may include an emergency protocol used to protect individuals inside the building from a dangerous external event. Lockout 430 may be utilized if an emergency situation occurred outside but nearby the building. Evacuate 440 may be selected by an AU if there were a need to move individuals away from the threat or actual occurrence of a hazard inside the building. For example, the evacuation of a building could be necessary due to a bomb threat or fire. Typically, most AUs would be authorized to send the first three types of alerts. An AU would broadcast an All Clear 450 alert when the incident is complete. Typically, only administrators or public safety personnel would be authorized to send such an alert. In addition to selecting the type of alert the AU would like to broadcast, there is an option for the AU to send a message 421, 431, 441, 451. For instance, if an administrator has broadcast a lockdown, he or she can add that it is due to the entry of a gunman on the premises. The message section can also be used by an administrator or public safety personnel to send an incident update.

Once the AU has indicated the type of alert and clicked on the Broadcast Alert 470 button, the broadcast message is received by all other AUs and public safety personnel by email, text message and on the Site. 480 As the incident transforms and progresses, an AU can continue to keep the staff and public safety personnel informed by issuing directives and incident updates. Incident updates can be used to transmit information to staff in real time, letting them know what is happening, what they need to do now and how to help. It can also help them communicate with those in their care, such as students, by informing them of what has occurred or is taking place. Additionally, it can be used for other emergencies, such as a medical emergency, to share information discretely with their staff.

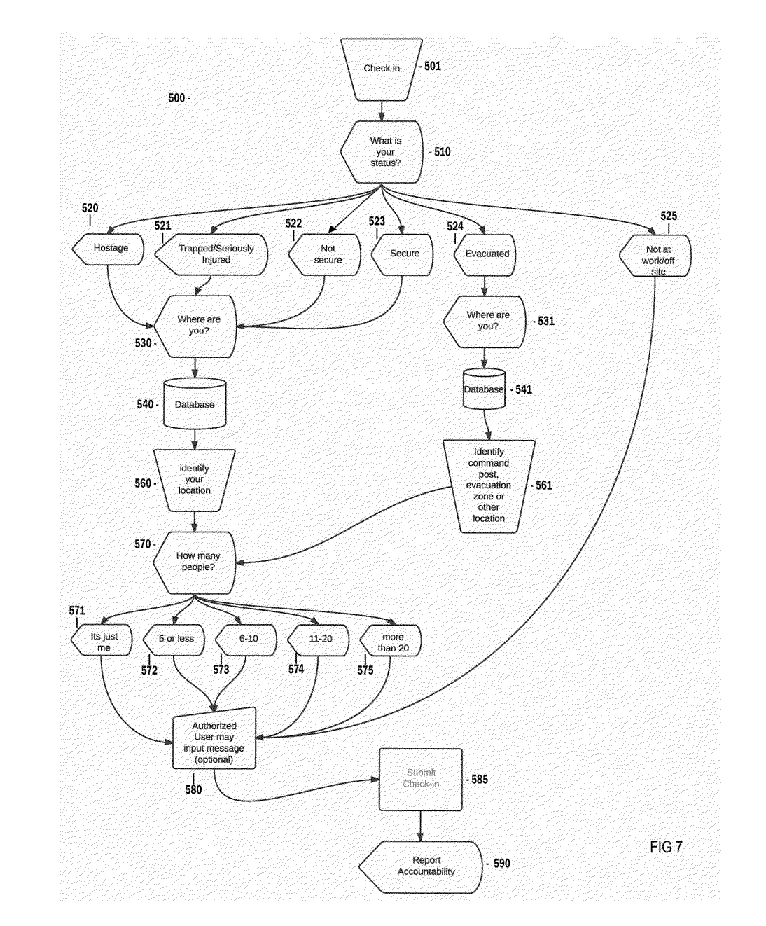

When a Broadcast Alert has been transmitted, it contains a link for each AU to “Check-In.” The Check-In feature of Share911 enables an AU to share his or her status, actual location (inside or out), headcount, a short message, and account for missing or found personnel. FIG. 7 is a logic flow diagram of how an AU checks in. 500

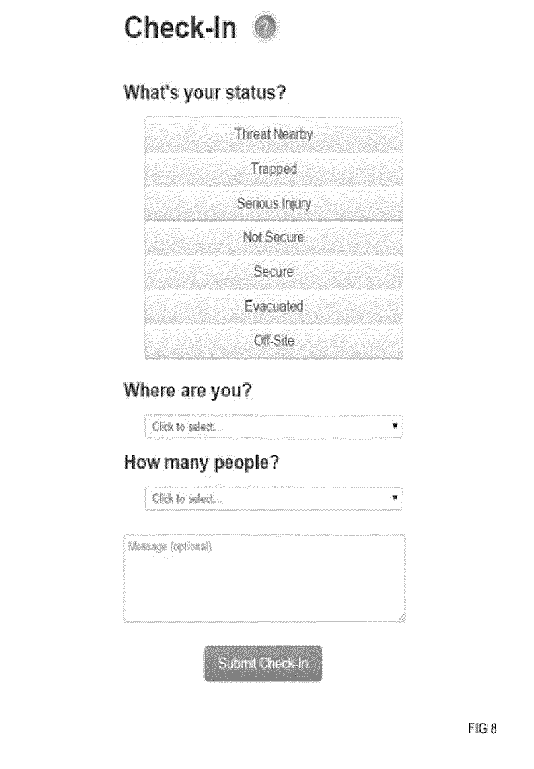

FIG. 8 is a screen shot showing how an AU checks in. The first step is for the AU to select his or her status. 510 When an AU checks-in, he or she must choose from a variety of options that are determined by the Inventive System's customer and are completely customizable based on the customer's desired use of the Inventive System. For instance, a hospital or zoo may want to include a status option that states “searching,” if an employee is searching for a missing patient or an escaped animal. In this embodiment, as exemplified in FIG. 7, the AU may choose from: (1) Hostage 520; (2) Trapped/seriously injured 521; (3) Not Secure 522; (4) Secure 523; (5) Evacuated 524; or (6) Not at Work/Off-Site 525. The AU's status indicates the level of priority or urgency to public safety personnel which helps them know where they need to go first. For example if an AU indicates that he or she is a hostage 520 or is trapped 521, it is more critical that AU get help than individual who has evacuated the building 524. If an AU indicates that he or she is not secure 522, that AU would be placed in priority 2 because he or she is unable to secure his or her location but is not being held hostage 520 or trapped 521. If an AU indicates that he or she is secure 523, it means that the AU is in a secure place (e.g., a locked classroom) and is in less danger than individuals in the first two categories 520, 521. If an AU indicates that he or she has evacuated 524, the AU is then prompted to indicate what evacuation zone he or she is in 531. The last option, “not at work or offsite” 525 is selected when personnel are not at work that day or currently off-site (e.g., out to lunch, at a meeting). Even though the AU is not at work that day, he or she still receives the Broadcast Alert and still must check in. It is important that these AUs indicate their status so that building administrators and public safety personnel do not spend time looking for them.

After the AU indicates his or her status 520, 521, 522, 523, 524, 525, the next step is to indicate where the AU is located 530, 531. A customized site for each Enabled Location 540, 541, is built on the Inventive System's platform. The customized site contains every possible location in the building (e.g., classrooms, cafeteria, offices, closets, storage rooms). The AU then identifies his or her location 560, 561.

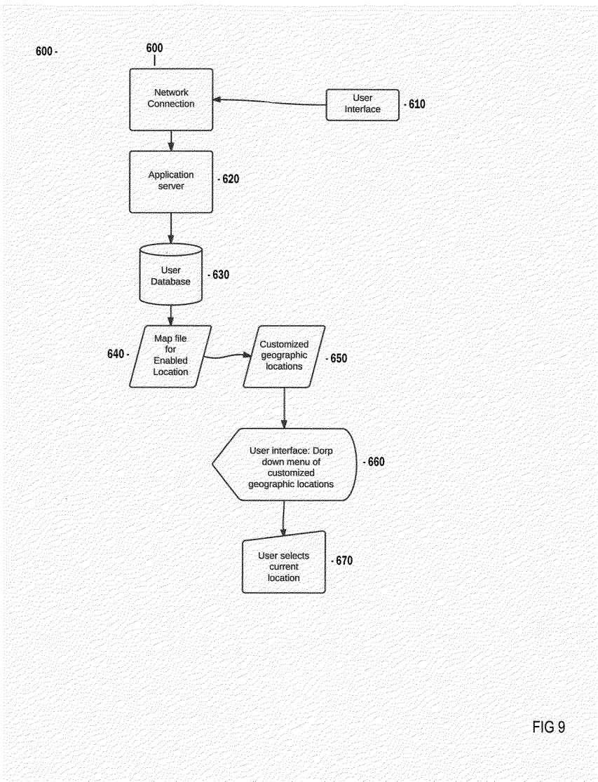

FIG. 9 is a logic flow diagram indicating the process through which the customized geographic locations are enabled for a building site on the Inventive System's platform. As shown in FIG. 9, there is a map file for each Enabled Location 640 which then provides the customized geographic locations 650 to the AU through a drop down menu 660 where the AU indicates his or her current location 670.

The final step in the check-in phase is for the AU to indicate how many people are with him or her 570. The AU is provided a list of options as to the amount of people present 571-575. FIG. 7 is provided as an example where, the AU has five options: (1) “its just me;” 571 (2) “5 or less;” 572 (3) “6-10;” 573 (4) “11-20;” 574 or (5) “more than 20.” 575 After an AU has indicated how many people are with him or her, the AU has the option to share a message 580. In the message box, an AU can, for example, indicate that there are individuals with him or her that are injured and need immediate assistance, that the AU has seen an armed intruder and provide details, that the AU has seen something suspicious, or that the AU smells or sees smoke and/or fire in a specific location. The AU then clicks on the “Submit Check-In” button 585 at the bottom of the screen, which takes the AU to the Report Accountability page 590.

The “Report Accountability” feature on the Inventive System's platform enables building administrators and incident commanders to account for all individuals who should be in the building at that time in real-time.

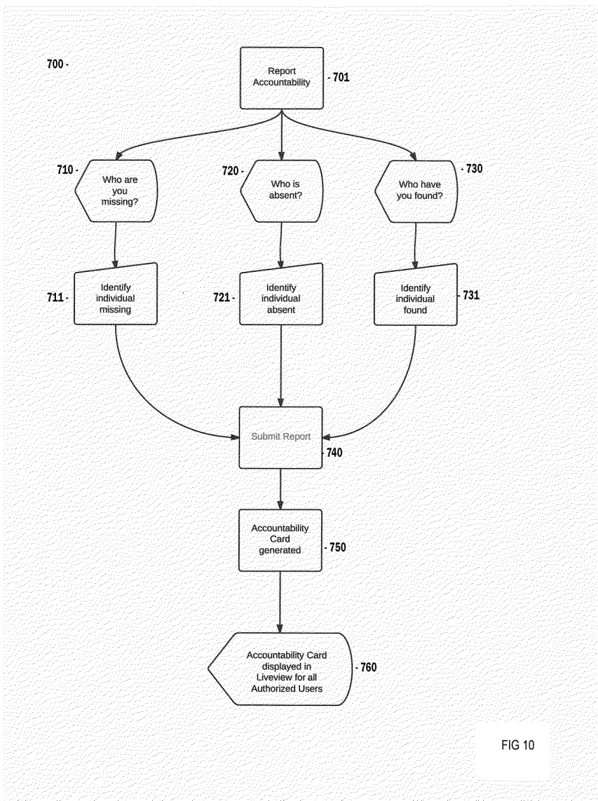

FIG. 10 is a logic flow diagram of how an AU reports individuals as missing, absent or found. 700

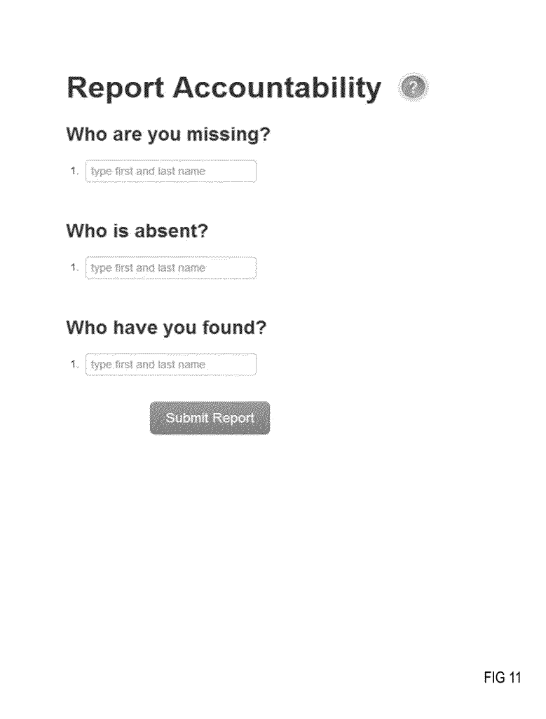

FIG. 11 is a screen shot of the Report Accountability page 701 on which an AU reports individuals as lost, absent or found. Once the AU is on the Report Accountability page, the AU indicates that an individual or another staff member that is normally with the AU at the time of the incident is missing by typing in the individuals name under the category “Who are you missing:” 710 The AU then indicates who is absent by typing in the individuals name under the category “Who is absent?” 720 Finally, if the AU has found an individual who is not normally with the AU at the time of the incident, the AU indicates who they have found by typing in the individuals name under the category “Who have you found?” 730 After the AU has input data (persons names) into each field 711 (missing), 721 (absent), 731 (found), if applicable, the AU clicks on “Submit Report” 740 and the system automatically generates a card 750 with the individuals name, location and status (an “Accountability Card” 750) which is available for all AU to see in real-time on the Liveview page 760. If an individual was reported lost by one AU and then found by a different AU, the Inventive system instantly matches up the data and generates an Accountability Card 750 that indicates that the individual that was originally reported lost has now been found. Similarly, if an individual was reported missing but then checks-in as evacuated, an Accountability Card 750 is generated that indicates that the individual that was originally reported as missing has evacuated the building and is presumably out of danger.

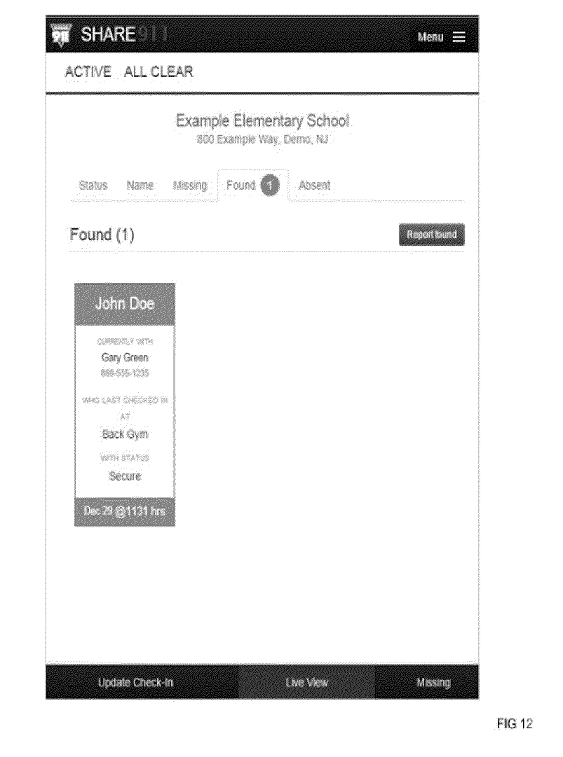

FIG. 12 is a screen shot showing an exemplary Accountability Card of an individual who was lost and then found.

Once the AU has checked-in, the information provided by the AU is displayed in real-time on Inventive System's LiveView page on the Site. This information is visible to every AU and public safety personnel. The LiveView page allows all AUs to see who in the building is a hostage, trapped or seriously injured, not secure, secure, not at work, evacuated or not reported. It allows building administrators and police to track who is missing and who has been located. The LiveView updates in real-time so there is no need for an AU to refresh the browser to see the most recent information. An AU can hover over an Accountability Card to see extended information (if provided) for each person, such as their emergency contact information.

In LiveView, an AU has four (4) possible views: (1) By Check-In Status (2) By Last Name (3) Missing Persons; and (4) Found Persons.

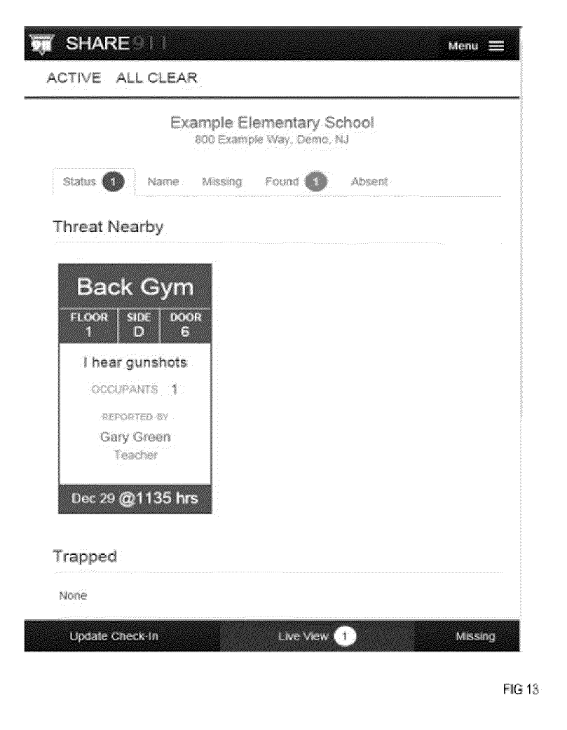

FIG. 13 is a screen shot showing a By Check-In Status View in LiveView. The By Check-In Status View enables an AU to see all of the check-ins in real-time, grouped by status and sorted by location.

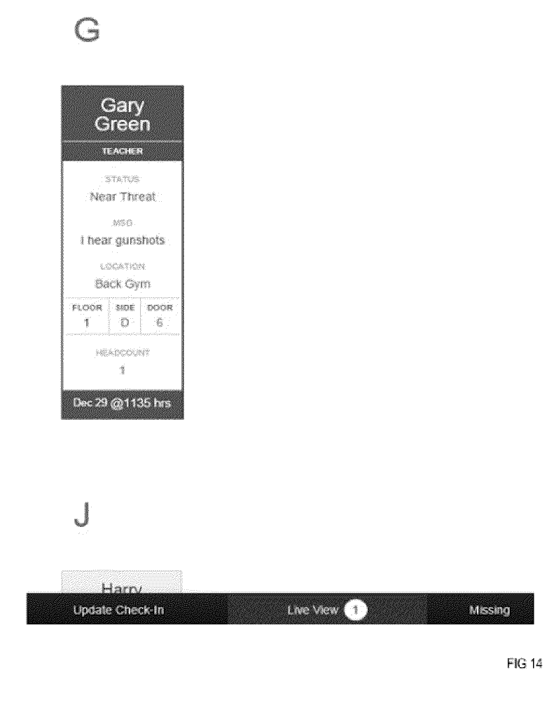

FIG. 14 is a screen shot showing the By Last Name View in LiveView. The By Last Name View enables an AU to see AUs, grouped by the first letter of their last name and sorted alphabetically by last name.

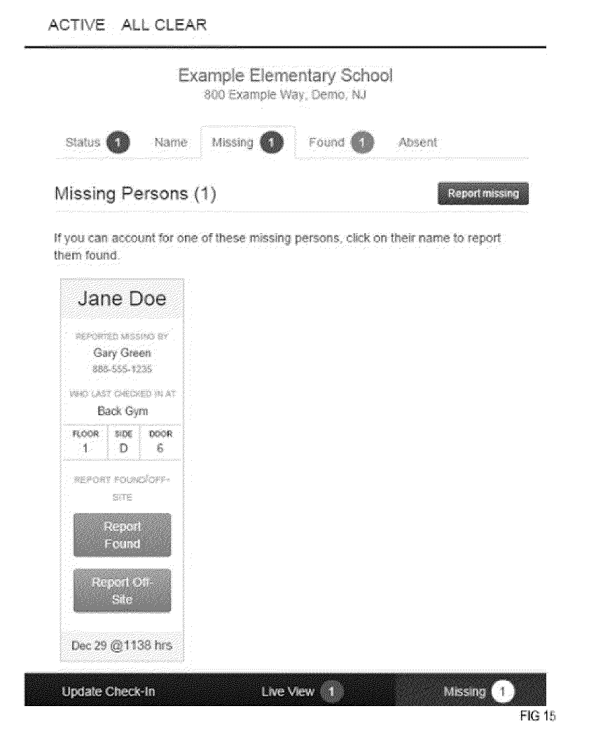

FIG. 15 is a screen shot showing the Missing Persons View of LiveView. The Missing Persons View enables an AU to see persons reported missing in real-time. In this view, an AU can account for a person who is shown as “missing” by tapping their name and clicking “Report Found” or “Report Off-site.” Once completed, the missing person will move to the Found Persons View. When two AUs match on the name of a missing/found person, it appears in the Found Persons View as located.

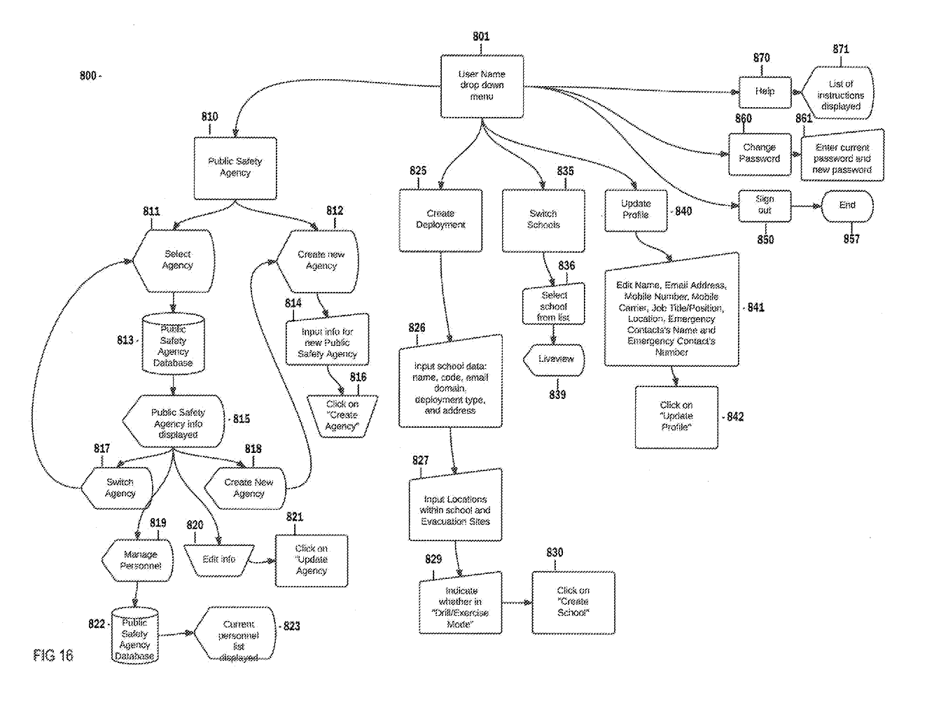

FIG. 16 is a logic flow diagram 800 of how an AU can access and/or edit public safety agency, school and user profiles. Depending upon an AU's Authorization Level, an AU can access and edit profiles for a specific public safety agency, school or the AU. An AU accesses these profiles through a drop-down menu 801 under the AU's name at the top of the screen. From this drop-down menu, an AU has the following options: (1) Public safety agency 810; (2) Create Deployment 825; (3) Switch Schools 835; (4) Update Profile 840; (5) Help 870; (6) Change Password 860; and (7) Sign out 850.

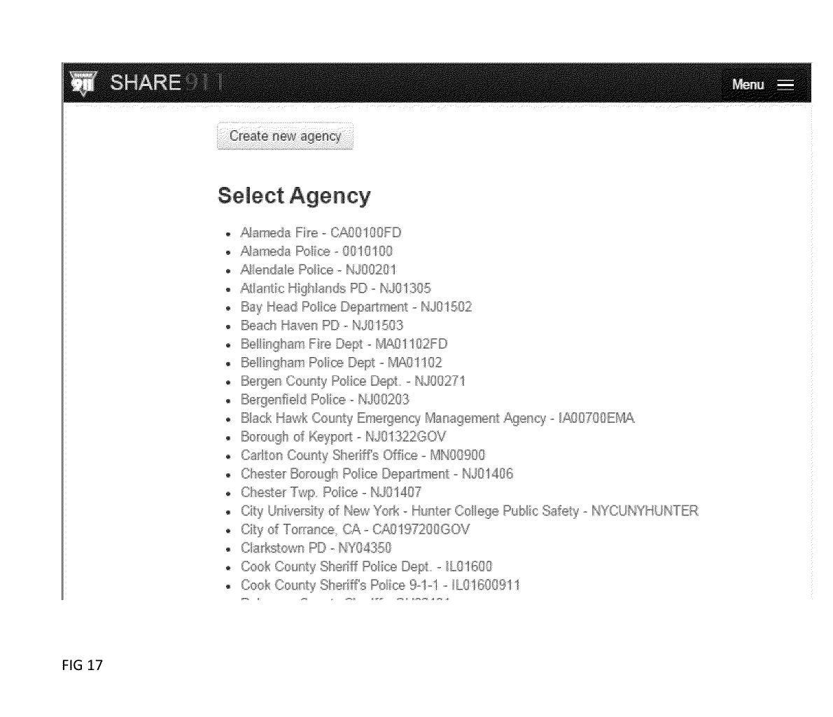

FIG. 17 is a screen shot showing what an AU would see when selecting “Public Safety Agency” from the drop-down menu. Once an AU selects “Public Safety Agency” from the drop-down menu, the AU has the option of either creating a new agency profile or accessing an existing agency.

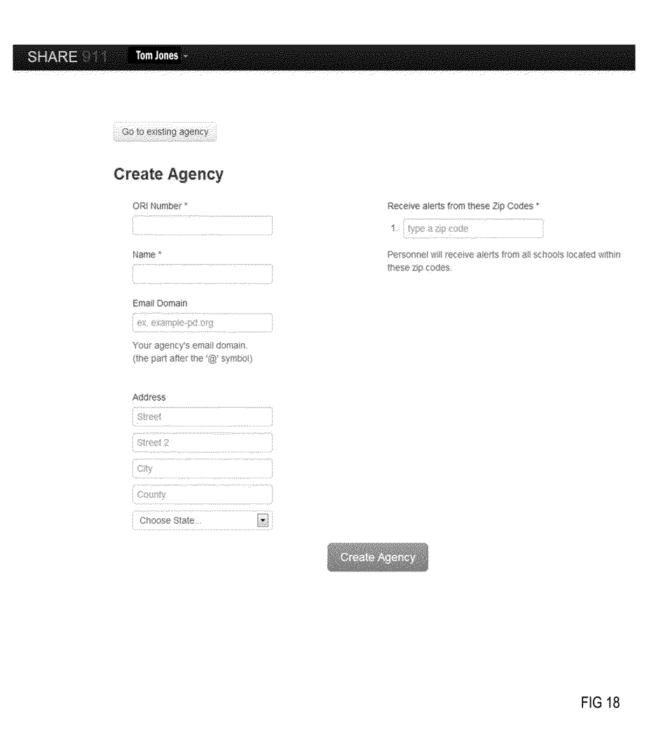

FIG. 18 is a screen shot showing the page on which an AU would input information to create a new public safety agency profile. To create a new agency profile, an AU inputs the name of the agency, the agency's email domain, the agency's address and the zip codes from which the agency would like to receive alerts. The AU then clicks on the button “Create New Agency” at the bottom of the page to create a new public safety agency profile.

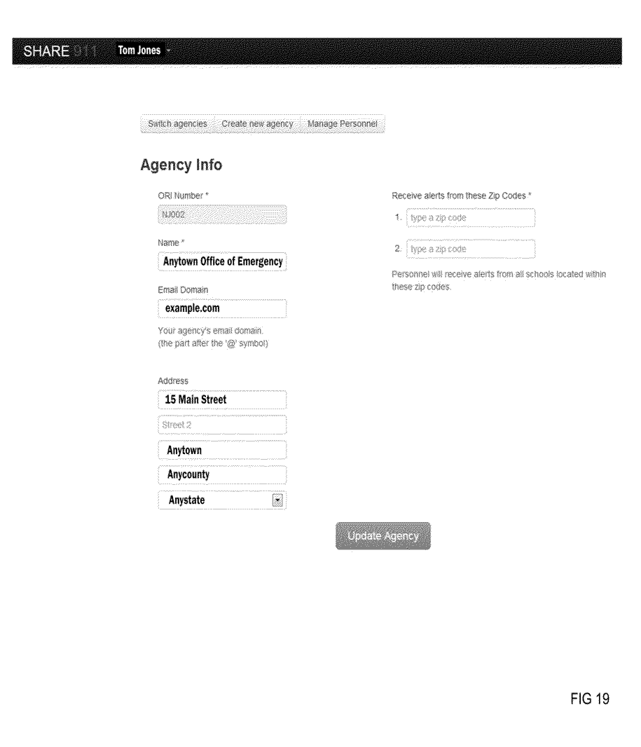

FIG. 19 is a screen shot showing the page on which an AU would view and/or edit information pertaining to an existing agency. To edit the profile of an existing agency, an AU may make changes to the name of the agency, the agency's email domain, the agency's address and the zip codes from which the agency would like to receive alerts. The AU then clicks on the button “Update Agency” at the bottom of the page to save the changes to the profile of the public safety agency. From the Update Agency page, an AU can also view a list of current personnel for that agency by clicking on the “Manage Personnel” tab on the top of the screen. This list provides the name and email address of each personnel, as well as the actions the personnel is authorized to perform (e.g., liveview, broadcast, manage-personnel, and manage-agency).

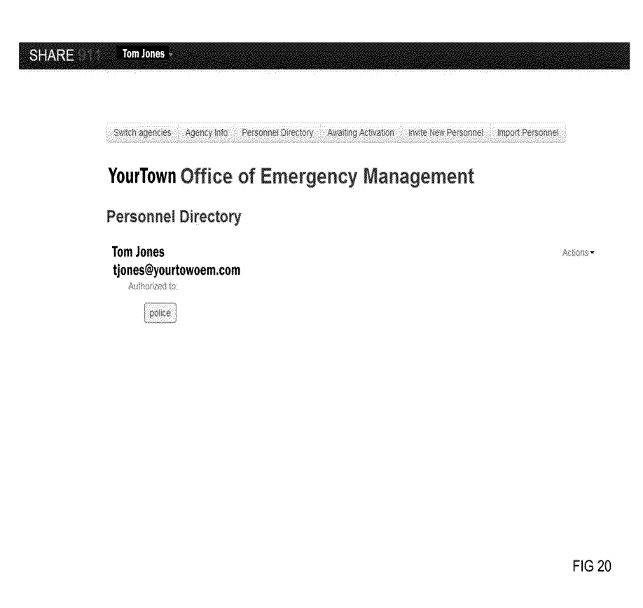

FIG. 20 is a screen shot showing an exemplary Current Personnel List. From the Current Personnel List page, an AU can add personnel the current list by clicking on the “Import Personnel” tab at the top of the screen. The AU is then taken to a screen that allows them to add the personnel by inputting a password and then the personnel information (i.e., name, email and mobile number).

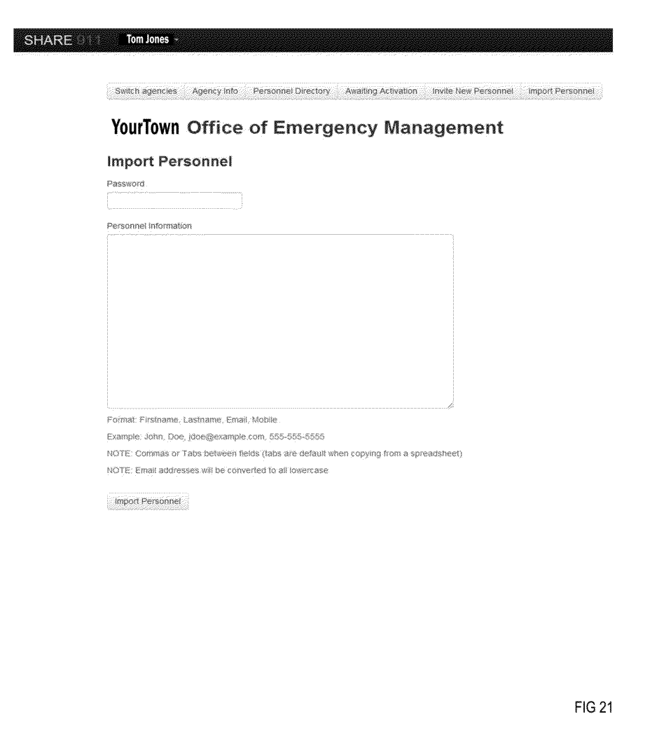

FIG. 21 is a screen shot showing a page on which an AU would import a public safety agency personnel.

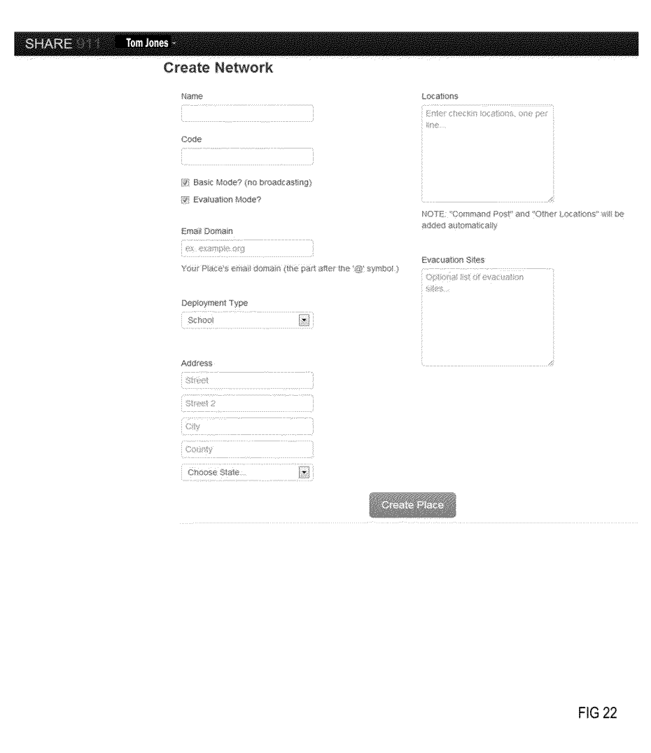

FIG. 22 is a screen shot showing the page on which an AU would input information to create a new school profile. To create a new school profile, an AU clicks on “Create Deployment” from the drop-down menu from the AU's name. The AU is then brought to a page on which the AU can create the new school profile by inputting all the necessary information (i.e., name, code, email domain, deployment type, address). The AU must also enter check-in locations and evacuation sites. These locations and evacuation sites will be coded and added to the school's mapping database to be accessed during the check-in phase of the Site. From time to time, a school may wish to engage in drills and/or exercises to prepare for the event of a real emergency. When the school wishes to engage in such activities, the AU may indicate on this page whether the school is in drill or exercise mode by checking the box next to “Drill/Exercise Mode.” After the AU has completed inputting all necessary information, the AU clicks on the “Create School” button at the bottom of the page and a new school profile is created.

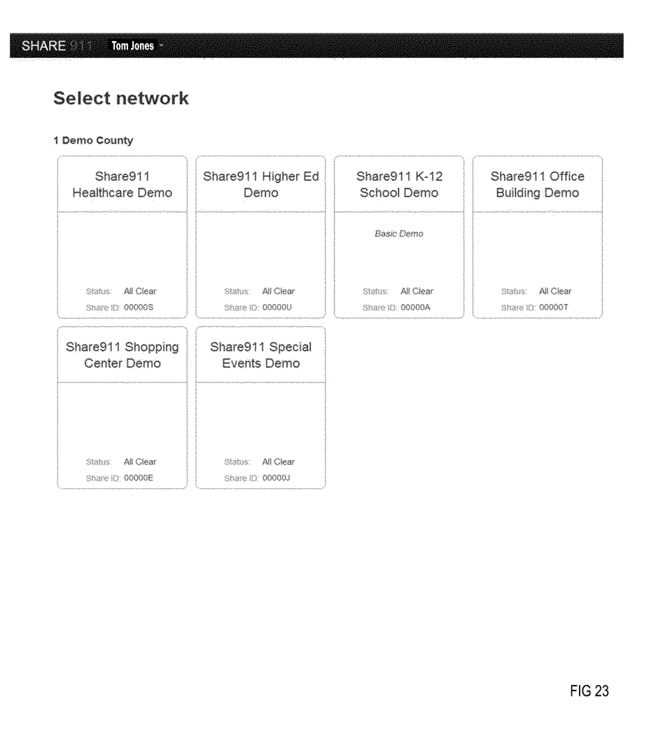

FIG. 23 is a screen shot showing the page an AU would see when switching networks. An AU can also update the AU's profile by choosing “Update My Profile” from the drop-down menu.

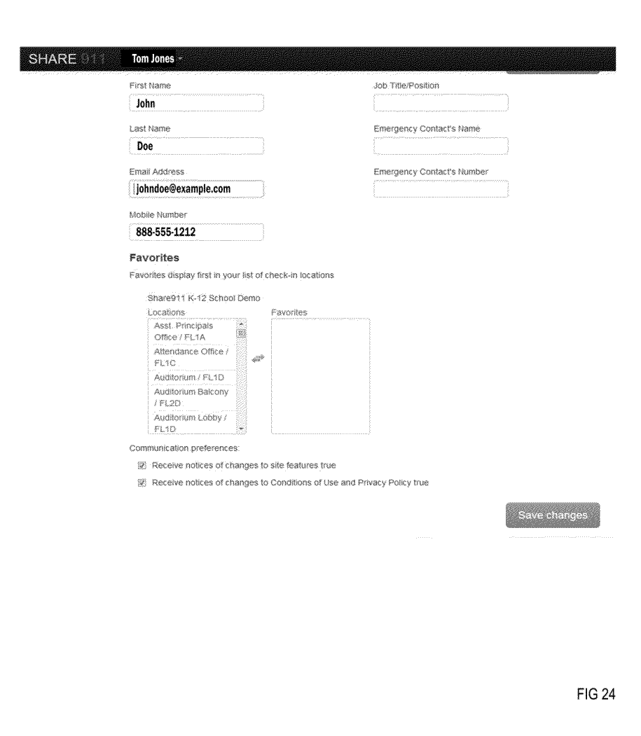

FIG. 24 is a screen shot showing the page an AU would see when updating the AU's profile. The AU makes the necessary changes to the AU's profile (i.e., name, email address, mobile number, mobile carrier, job title/position, emergency contact's name and emergency contact's number). The AU can also identify certain locations which will be displayed first in the AU's list of check-in locations. Once the AU makes the necessary changes, the AU clicks on the button “Update Profile” at the bottom of the page and the changes are saved to the AU's profile.

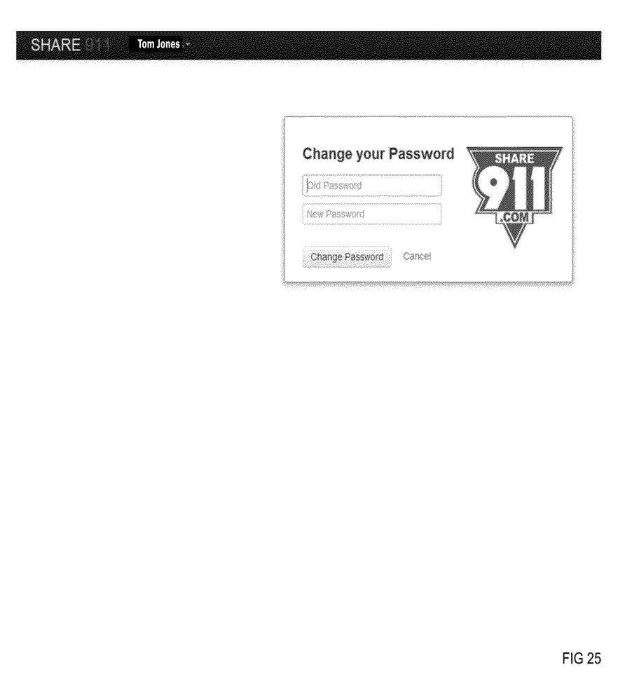

FIG. 25 is a screen shot showing the page that an AU would see when changing the AU's password. This option is available from the drop-down menu under the AU's name. The AU simply enters their current password, the new password and clicks on the button “Change Password.” If an AU is having difficulty using the Site, the AU may select help from the drop-down menu below the AU's name.

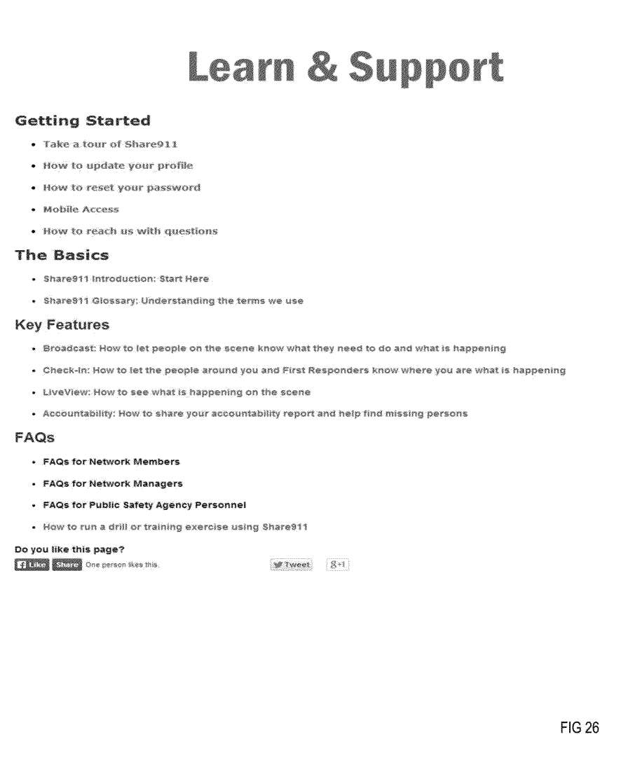

FIG. 26 is a screen shot showing the directions for using the Inventive System that are contained on the Site under “Help.” An AU may sign out by choosing “Sign Out” from the drop-down menu under the AU's name. This will terminate the AU's access to the Inventive System's platform.

The buildings (i.e., schools), and emergency situations related thereto, described above, are illustrative examples and it should not be construed that the present invention is limited to these such buildings and emergency situations. Thus, various changes and modifications may be effected by one skilled in the art without departing from the spirit or scope of the invention as described above.

1. A method for providing a location-based, emergency social network, comprising the steps of:
configuring a network profile comprising:
a name of a place associated with an address;
an email domain associated with an entity that occupies the address;
a unique network identifier specific to a network profile;
an identifier regarding the type of place or entity that occupies the address;
a physical address, comprising indicators selected from the group consisting of:
street address, city, county, state, zip code, and combinations thereof, where the place is physically located;
a time zone associated with the physical address; and
a password;
configuring a check-in location for each unique place, associated with the network profile, from which a network user may select indicators selected from the group consisting of: a location name, a floor of the building, a side of the building, a closest entry door, and combinations thereof;
configuring a network user profile, wherein a plurality of data inputs from the user is selected from the group consisting of: a user's name, an email address, a password, a mobile phone number, a job title, a position title, a name of an emergency contact, a phone number of an emergency contact, a user's preference for receiving alerts, a selection of favorited check-in locations, and combinations thereof;
configuring an agency profile, wherein said agency profile is associated with a public safety agency and wherein said agency profile comprises information selected from the group consisting of: an originating agency identification number, a name of an agency, an email domain associated with the agency, a physical street address, a zip code associated with a network profile for which members of the agency may have access and visibility to, and combinations thereof;
configuring an agency user profile, wherein the plurality of data inputs from the user comprises: an agency user's name, an agency's email address, a password, a mobile phone number, a job position, a job title, an agency user's preferences for receiving alerts from each network, and combinations thereof.

2. A method for a network user or agency user to issue an emergency alert to a plurality of users associated with a network profile of an emergency situation comprising:
selecting a type of emergency alert from a pre-determined list of stored alerts;
identifying the recipients of the emergency alert by a location, wherein the location is selected from the group consisting of a floor of a building, wherein the location is associated with a network profile, a network user's profile, and a check-in location shared by a network user;
attaching a text based, user-generated message to an emergency alert;
sending the selected emergency alert and message to a server for distribution;
utilizing a server to attach a link associated with the emergency alert created by a user to where the link enables a viewing user to share with or view information shared by the plurality of users; and
delivering the emergency alert, message, and link to the plurality of users and agency users associated with a network profile, based on each users preference for receiving alerts, wherein said alerts may be selected from the group consisting of: an SMS message, a text message, an email, a desktop notification, an online notification, and combinations thereof.

3. A method for a network user or agency user to issue an emergency message to a plurality of users associated with a network profile of an emergency comprising:
identifying the recipients of the emergency message by the floor or floors of a building which are associated with the network profile, the network users profile, and check-in location shared by a network user;
attaching a textual, user-generated emergency message;
sending the selected emergency message to a server for distribution; and
delivering the emergency message to the plurality of network users and agency users associated with a network profile, based on each users preference for receiving alerts, wherein said alerts may be selected from the group consisting of: an SMS message, a text message, an email, a desktop notification, an online notification, and combinations thereof.

4. A method for each network user to share emergency information, in the form of a check-in, with a plurality of users associated with a network profile comprising:
generating a server-supplied user interface to each user, for the purpose of checking-in;
receiving the status of the network user from a list of statuses stored in a database associated with a network profile;
receiving the location of the network user from a list of locations stored in a database associated with a network profile;
receiving the number or range of people who are with a network user from a list of numbers or ranges stored in a database associated with a network profile;
receiving a textual message from the network user;
receiving the first and last name(s) of persons who the network user is reporting to be missing, found, absent or off-site;
attaching the users check-ins status, location, headcount, textual message and the names of missing, found, absent or off-site persons; and
sending the attachment to the server.

5. A method for each network user or agency user to view, in real-time, the emergency information, known as check-in's, as it is being shared by the plurality of users associated with a network profile comprising:
storing, in a database on a server, the emergency information being shared by the plurality of users;
generating a server-supplied user interface to each user for the purpose of providing real-time visibility to the emergency information being shared by the plurality of users;
associating the data contained in the network user profile with the check-in data the network user has shared for the purpose of displaying a status card that associates that information;
organizing and displaying in real-time, the emergency information, being shared by the plurality of users, based on the chronological order in which it was shared;
organizing and displaying in real-time, the emergency information, being shared by the plurality of users, based on the status selected by each user;
organizing and displaying in real-time, the emergency information, being shared by the plurality of users, based on the location selected by each user; and
organizing and displaying in real-time, the emergency information, being shared by the plurality of users, in alphabetical order based on the last name of each user.

6. A method for each network user or agency user to view, in real-time, the network users who have not shared emergency information or checked in to a network profile comprising:
storing, in a database on a server, the profile information for each network user associated with a network profile;
generating a server-supplied user interface to each user for the purpose of providing real-time visibility to the emergency information or check-in status of each network user;
organizing and displaying the network profile information for those network users who have not shared emergency information or checked in as “not reported”; and
enabling each network user to share emergency information or check-in on behalf of a network user who is displayed as “not reported” by interacting with their “status card.”

7. A method for each network user or agency user to share or view, in real-time, names or identities of people who have been reported missing, found, absent or off-site by the plurality of users associated with a network profile comprising:
storing, in a database on a server, the data, the names or full name of people who have been reported missing, found, absent or off-site by each network user or agency user;
generating a server-supplied user interface to each user for the purpose of providing real-time visibility to a user's accountability status cards that contain the names of people who have been reported missing, found, absent or off-site shared by the plurality of users;
associating the data contained in the network user profile with the check-in data the network user has shared, with the names of people who they have reported missing, found, absent or off-site for the purpose of displaying an accountability status card that contains that information; and
enabling each network user or agency user to account for persons reported missing by interacting with their specific accountability status card.
